(19) United States
(12) Patent Application Publication
(10) Pub. No.: US 2006/0110493 A1
(43) Pub. Date: May 25, 2006

(54) Snack having a soft edible layer and method of making

(75) Inventors: Joan Schnieber, Belvidere, NJ (US); Amy Dombroski, Stanhope, NJ (US); Jalaj Bhatt, Basking Ridge, NJ (US)

Correspondence Address: FITZPATRICK CELLA HARPER & SCINTO, 30 ROCKEFELLER PLAZA, NEW YORK, NY, 10112, US

(73) Assignee: MARS, INCORPORATED, MCLEAN, VA (US)

(21) Appl. No.: 10/524,369

(22) PCT Filed: Aug. 14, 2003
(86) PCT No.: PCT/US03/25439

§ 371 Date: Oct. 31, 2005

Related U.S. Application Data
(60) Provisional application No. 60/403,267, filed on Aug. 14, 2002.

(51) Int. Cl. A23L 1/36

(52) U.S. Cl. 426/93

(57) ABSTRACT

The present invention is directed to a method of making a shelf stable edible snack. The method comprises the steps of: (A) providing an edible core having an outside surface; and (B) applying at least one soft edible layer that substantially covers the outside surface of the edible core; wherein the outer layer is applied by a method comprising the steps of: (a) applying a base liquid onto the outside surface of the edible core, thereby forming a liquid coated component; (b) applying a dry powder to the liquid coated component, thereby forming an edible layered component; and (c) optionally, (i) drying the liquid coated core after step (a), (ii) drying the edible layered component after step (b), or (iii) drying the liquid coated core after step (a) and drying the edible layered component after step (b); wherein the soft edible layer has a water activity of about 0.2 to about 0.8 at 25° C.

### CROSS-REFERENCE TO RELATED APPLICATIONS

This application claims the benefit of U.S. Provisional Application Ser. No. 60/403,267 that was filed on Aug. 14, 2002, the contents of which are incorporated by reference.

### BACKGROUND OF THE INVENTION

1. Field of the Invention

The present invention is directed to edible snack foods. More particularly, the present invention is directed to shelf stable edible snack foods that comprise an edible core that is substantially covered by a soft edible layer.

2. Related Background Art

Snack foods are popular items that many consumers like. Consumers buy them as treats for themselves or for their pets. One of the reasons why they are so appealing is that they generally taste good. Many snacks are also designed to have a convenient serving size, which consumers also like. Another positive attribute is that they require little to no preparation time, making them for the most part, ready-to-eat.

Snacks are available in a variety of forms and are made in a variety of ways. One particular type of snack is designed with a center filling that is surrounded by an outer shell. These snacks may be made by processes that include enrobing and extruding. Often, these snacks are coextruded, where an outer shell surrounds a central core of material. Coextruded snacks have wide appeal because of the unique combining of texture, composition, color, or flavor between the central core from the outer shell material. Often, the shell and core materials are processed in separate extruders. The separate materials are then extruded through concentric dies in a die plate mounted across the discharge end of one of the extruders. Typically the two extruders are positioned perpendicular to one another, with the discharge ends of the extruders abutting one another. One of the materials is extruded and forms the outer shell portion, which is a hollow rope. The other material is extruded simultaneously into the hollow portion of the outer shell rope, forming the center filling. This process requires significant capital investment in equipment and is difficult to maintain and operate, making it an undesirable way to manufacture a snack food product. Moreover, some ingredients and components that are sticky or difficult to handle are difficult to extrude.

Thus, a simpler method of applying an outer layer over a food core to manufacture snack foods is desired.

### SUMMARY OF THE INVENTION

The present invention is directed to a method for manufacturing a shelf stable edible snack. The method comprises the steps of: (A) providing an edible core having an outside surface, and (B) applying at least one soft edible layer that substantially covers the outside surface of the edible core, wherein the soft edible layer is applied by the method comprising the steps of: (a) coating the outside surface of the edible core with a base liquid, thereby forming a liquid coated core; (b) applying a dry component to the liquid coated core, thereby forming an edible layered component, and (c) optionally, (I) drying the liquid coated core after step (a), (ii) drying the edible layered component after step (b), or (iii) drying the liquid coated core after step (a) and drying the edible layered component after step (b), wherein the soft edible layer has a hardness value of 6 or less as measured by. Descriptive Analysis Testing (ASTM Manual Series MNL13).

In an alternative embodiment, the method for making a shelf stable edible snack comprises the steps of: (A) providing an edible core having an outside surface, and (B) applying at least one soft edible layer that substantially covers the outside surface of the edible core, wherein the soft edible layer is applied by a method comprising the steps of: (I) coating the outside surface of the edible core with a liquid suspension comprising one or more components selected from the group consisting of: corn syrups, glycerin, salt, fats, flavorings, acids, lecitlnn, fruit juices, fruit juice derivatives, powdered sugars, wheat flours, peanut flours, cheese powders, milk powders, yogurt powders, salt, dextrose, cream cheese powders, maltodextrin, flavorings, herbs, spices, emulsifiers, enzymes, and mixtures; and (ii) optionally, drying the coated core.

Included in the present invention is a shelf stable edible snack comprising an edible core selected from the group consisting of: nuts, nut derivatives, meats, meat derivatives, fruits, fruit derivatives, cookie bits, crackers, cheese, cheese derivatives, legumes, yogurts, yogurt derivatives, tomato sauces, vegetables, vegetable derivatives, confectioneries, and mixtures thereof; and a soft edible layer, wherein the soft edible layer substantially surrounds the edible core and the soft edible layer has a water activity that is less than about 0.8 at 25° C.

### DETAILED DESCRIPTION OF THE INVENTION

The present invention provides a novel method for making a shelf stable edible snack that has an edible core and a soft edible layer, e.g., peanut butter, jelly, cheese, caramel, and the like. The soft edible layer is applied in a unique way, where the soft edible layer food is applied as a coating. In a preferred embodiment, the peanut butter, jelly, cheese, caramel, or other variant is separated into two components, and applied as a separate liquid and a separate dry component. The combination of the two components forms a layer of food over the edible core surface. This new and unique method of making a food snack is particularly useful when making a product that has a soft, sticky, or tacky outer layer.

The term “shelf stable” is understood to mean that the product has a microbiologically stable shelf life and/or organoleptic stable shelf life of at least about 2 months when subjected to environmental conditions where the-temperature is about 40° F. to about 80° F. and the relative humidity is about 25% to about 75%. That is, the shelf stable edible snack does not experience microbiological spoilage and/or is organoleptically stable under these conditions. More preferably, the environmental conditions are such that the temperature is about 55° F. to about 65° F. and the relative humidity is about 50% to about 60%. The shelf life of the shelf stable edible snack is preferably at least about 6 months. More preferably, at least about 9 months. Preferably, the shelf stable edible snack is-microbiologically stable without the use of preservatives.

In one embodiment, the shelf stable edible snack is a bite sized snack. The term “bite sized” is used herein to denote products that resemble and/or are similar to normal sized products, but are sized so that the whole product or most of the product can be conveniently placed inside a consumer's mouth. Bite sized products often tend to be about 1 to about 6 cm in length.

Staling of products is well recognized in the industry as a major issue. The shelf stable edible snack is desirably essentially free of staling for at least 2 months, preferably at least 6 months, and most preferably at least 9 months. The degree of staling is determined by performing a Degree of Difference test using a trained sensory panel. A scale from 1 to 6 is used. Products rated a 1 are said to be identical to products that are fresh. A rating of 3 indicates that there is a perceivable difference. A rating of 4 or more indicates a strong difference.

The method of the present invention comprises the step of applying at least one soft edible layer that substantially surrounds or covers the edible core, wherein the soft edible layer is applied by coating the surface of the edible core with a base liquid. This is followed by applying a dry component onto the liquid coated core. In addition, one or more drying steps may be included. Drying may be performed after the surface of the edible core is coated with the base liquid or after applying the dry component to the liquid coated core, or after each step. Whether the drying step is needed or not will be determined by factors such as the ingredients, product design, and process conditions. Moreover, the base liquid and dry component may be applied multiple times in order to build up the thickness of the soft edible layer. Alternatively, the thickness of the exterior surrounding the edible core may be built up by coating the edible layered component with a second liquid and if so desired, applying a second dry component onto the liquid coated component. These steps can be repeated as often as needed to develop the desired outer layer thickness.

The soft edible layer has a hardness value of 6 or less as determined by Descriptive Analysis Testing found in ASTM Manual Series MNL13 (published in Philadelphia in 1992) Chapter 4. The descriptive analysis testing is well known to one skilled in the art for evaluating the texture of a product. A trained panel evaluates a product and rates the product on a scale from 1 to 15. A score of 6 or less is given a soft rating. Higher scores would be labelled as firm or hard.

Preferably, the soft edible layer has a water activity of less than about 0.8 at 25° C.

The shelf stable edible snack of the present invention is preferably made using a coating process. The process applies a base liquid onto the surface of the edible core, which substantially covers the surface of the edible core. This is followed by applying a dry component onto the somewhat tacky surface of the edible core. The dry component should be applied in a manner that facilitates even coverage of the piece. For example, in a panning operation, the pan would be charged with the edible cores. As the pan rotates at a preset number of revolutions per minute, the edible cores move around in a tumbling fashion. A measured amount of a base liquid is applied onto the edible cores. The mixing created by the tumbling action distributes the base liquid over the edible core pieces. Next, a dry component, such as milk powder, is applied over the liquid coated edible core pieces. Again, the tumbling action is used to spread the dry component over the edible core pieces. In a preferred embodiment, one or more drying steps are included. Drying may be performed after the edible core pieces are liquid coated and/or after the dry component is applied. Typically, conditioned air, i.e. air at a controlled temperature and humidity, is introduced into the apparatus/equipment to facilitate drying.

Equipment suitable for performing coating operations include, coating pans, mixing vessels, coating tubes, fluidized bed dryers, and the like.

The edible core may be any food product. Non-limiting examples include nuts, nut derivatives (e.g., peanut butter), meats, meat derivatives (e.g., spam, pepperoni), fruits, fruit derivatives (e.g., jelly), cookie bits, crackers, cheese, cheese derivatives (e.g., imitation cheese), legumes, yogurts, yogurt derivatives (e.g., yogurt powder), tomato sauces, vegetables, vegetable derivatives (e.g., sun dried tomato), confectioneries, and mixtures thereof In addition, the edible core may be formed by any suitable process. For example, starch-molding, roll depositing, extrusion, coextrusion, layering, and coating are just some of the processes that may be utilized or combined together.

In one particular embodiment, the edible core is formed by applying a food coating around a central core. The coating may be applied by any suitable method. For example, the central core may be a meat filling, which is then coated with a cheese coating or the central core may be a liquid coated with an outer coating to hold the liquid. The resulting component would then be used as the edible core of the present invention. It should be understood that more than one coating may be applied over the central core in order to form the edible core.

The thickness of the soft edible layer may be built up by applying a second liquid over the layered edible cores. This is usually followed by applying a second dry component onto the wetted liquid coated cores. These steps are repeated until the desired thickness is achieved In one embodiment, these steps are repeated from about 1 to about 25 times.

The second liquid may be the same or different from the base liquid. The same is true for the second dry component. That is, the second dry component may be the-same or different from the dry component. If the second liquid and the second dry component are the same as the base liquid and the dry component, then the application of these materials will build up the thickness of the layer. If either one of the second liquid or the second dry component are different from the base liquid or the dry component, then the application of these materials results in a new layer.

The thickness of the soft edible layer is determined by product design requirements. In general, the thickness of the soft edible layer is from about I- mm to about 6 mm, preferably between about 1 mm to about 3 mm, and more preferably between about 1 mm to about 2 mm.

As stated above, the soft edible layer is formed by applying a base liquid and then applying a dry component. This may be performed using a batch, semi-batch or continuous process. The base liquid may be comprised of glycerin, salt, and a liquid carrier, such as water and/or corn syrup. Or in one embodiment, the base liquid is a liquid carrier such as water and/or corn syrup.

The dry component is comprised of one or more dry ingredients. Suitable dry ingredients include, but are not limited to, powdered sugars, wheat flours, peanut flours, cheese powders, milk powders, yogurt powders, salt, dextrose, cream cheese powders, maltodextrin, flavorings, herbs, spices, emulsifiers, enzymes, and mixtures thereof In one preferred embodiment the dry component is a non-sucrose containing component. Particularly preferred enzymes are those enzymes that have an anti-staling affect on the product. In a preferred embodiment, the present inventors have discovered that by roasting a portion or all of the dry component, flavor attributes are developed in the dry component. It appears that roasting a portion or all of the dry component imparts a significant amount of flavor into the dry component and as the soft edible layer is applied, a cooked flavor is already present.

Optionally, the method for making the shelf stable edible snack may include a cooking step, which is typically performed after the soft edible layer is applied. Any suitable means of cooking may be used. For example, the shelf stable edible snack may be cooked by baking, microwaving, frying, steaming, boiling, broiling, roasting, dielectric heating, ultrasonic heating, high pressure low temperature heating, and the like. Preferably, the shelf stable edible snack is baked in an oven that tumbles the shelf stable edible snack as it is being baked. This may be accomplished by positioning a rotating apparatus, e.g., drum, inside an oven or by designing an oven that rotates as it heats the product The tumbling action assists in cooking the shelf stable edible snack evenly. In a preferred embodiment, the cooking step is a baking step which is performed at a temperature of from about 135° C. to about 235° C., preferably from about 176° C. to about 204° C., for a period of less than about 15 minutes, preferably about 2 minutes to about 10 minutes.

In one particularly preferred embodiment, the shelf stable edible snack is subjected to a freezing step before cooking, e.g., baking. Applicants have found that when the shelf stable edible snack pieces are frozen to a temperature of about −10° C. to about 40° C., the cooking step may be performed at a higher temperature for a shorter period of time. A preferred frozen temperature is about −30° C. to about −20° C. In the frozen state, the soft edible layer can be rapidly baked at a higher temperature, while minimizing the exposure of the edible core to high temperature effects. For example, the shelf stable edible snack pieces may be frozen for two hours and then baked at from about 135° C. to about 235° C. for a period of less than about 12 minutes. Preferably the frozen snack is baked at a temperature from about 175° C. to about 235° C., for about 3 minutes to about 10 minutes.

The shelf stable edible snack may take the form of various shapes as required by the product design. However, it is preferred that the shelf stable edible snack have a substantially spherical shape or lentil shape. This is desirable because a spherical or lentil shape facilitates the application of an even outer layer coating surrounding the edible core.

Moreover, the shelf stable edible snack may be further shaped after the soft edible layer is applied. The product may be manipulated using any means necessary to obtain the desired shape. In one example, a shelf stable edible snack may be compressed in a mold, giving it a sandwich shape.

Additional processing steps may be utilized to facilitate processing. For example, a non-sticking agent, such as flour, may be introduced into the coating apparatus prior to or after introducing the edible core pieces. The non-sticking agent reduces the sticking between the edible core pieces. Another beneficial step that may be included is to freeze or chill the edible core pieces prior to applying the liquid and/or dry component. This helps maintain the shape of the pieces during processing.

In another aspect of the present invention, the soft edible layer provides the shelf stable edible snack with a unique texture. This is a result of the layer that is gradually built up during the coating process that is used to apply the soft edible layer. The shelf stable edible snack may have a soft edible layer with a soft texture, or if the shelf stable edible snack is cooked, the texture of the soft edible layer may be soft or chewy.

The color of the shelf stable edible snack may be any color as determined by product design requirements.

The size of the shelf stable edible snack is also largely determined by product design requirements. In general, the weight of the edible snack is about 5 to about 20 grams, with the edible core weighing about 3 to about 15 grams and the outer layer coating about 5 to about 17 grams.

In an alternative embodiment, the method for making a shelf stable edible snack comprises the steps of: (A) providing an edible core having an outside surface; and (B) applying at least one soft edible layer that substantially covers the outside surface of the edible core, wherein the soft edible layer is applied by coating the edible core with a liquid suspension comprising one or more components selected from the group consisting of: corn syrups, glycerin, salt, fats, flavorings, acids, lecithin, fruit juices, fruit juice derivatives, powdered sugars, wheat flours, peanut flours, cheese powders, milk powders, yogurt powders, salt, dextrose, cream cheese powders, maltodextrin, flavorings, herbs, spices, emulsifiers, enzymes, and mixtures thereof. In a preferred embodiment, the soft edible layer has a water activity of less than about 0.8 at 25° C.

Optionally, the liquid coated edible component may be further processed by applying additional applications of the liquid suspension onto the edible component. Preferably, from about 1 to about 25 applications are applied.

The base liquid of the present invention is typically applied first to impart a tacky texture to the surface of the edible core. This makes application of the dry component more successful. Ingredients such as glycerin, salt, and a liquid carrier, e.g., corn syrup, and/or water, typically make up the base liquid. Preferably, the base liquid is comprised of at least one ingredient selected from the group consisting of corn syrup, water, glycerin, salt, fat, fruit juices, fruit purees, emulsifiers, colors, flavors, texturizers, and mixtures thereof.

Corn syrup may be included in the base liquid to raise the solids content. Not all corn syrups have the same composition, in fact, there is a considerable range depending primarily on the extent of hydrolysis used in their preparation In the present invention, the corn syrup preferably has a dextrose equivalent (DE) of about 4 to 68, more preferably about 30 to 50. Corn syrups have a characteristic flavor of their own, and if used in excessive amounts they may interfere with the flavor of the shelf stable edible snack. If corn syrup is included, it is from about 0 wt. % to about 25 wt. % of the total weight of the base liquid. Preferably, from about 5 wt. % to about 25 wt. %.

The soft edible layer of the shelf stable edible snack is design to be a peanut butter, jelly, cheese, caramnel, cream cheese, cookie dough, fruit, grain based, and the like. Typically, ingredients such as, corn syrups, glycerin, salt, fats, flavorings, acids, lecithin, fruit juices, fruit juice derivatives, powdered sugars, wheat flours, peanut flours, cheese powders, milk powders, yogurt powders, salt, dextrose, cream cheese powders, maltodextrin, flavorings, herbs, spices, emulsifiers, enzymes, preservatives, and mixtures thereof may be used to make the soft edible layer.

In a preferred embodiment, the dry component is fat based, dough based, dairy based, protein based, grain based or mixture thereof

The dry component is comprised of at least one dry ingredient selected from the group consisting of powdered sugars, wheat flours, peanut flours, cheese powders, milk powders, yogurt powders, salt, dextrose, cream cheese powders, maltodextrin, flavorings, herbs, spices, emulsifiers, enzymes, and mixtures thereof. Additional non-limiting examples of the dry ingredients include, sugar, protein, gums, soluble fiber, insoluble fiber, colorings, texturizers, vitamins, minerals, and mixtures thereof.

In another preferred embodiment, the soft edible layer has a degree of crystallinity that is less than about 30%, preferably less than about 20%, more preferably less than about 10%, and most preferably less than about 5% as measured by X-Ray diffraction.

In addition, the density of the soft edible layer is about 0.99 g/cc or greater, more preferably 1.1 g/cc or greater and most preferably about 1.2 g/cc or greater.

Using a Bohlin Controlled Stress Rheometer, the viscosity of the soft edible layer was measured. At a temperature of 20° C., the soft edible layer has a viscosity of about 0.2 to about 7.5 kPa-s, preferably the viscosity is about 0.7 to about 7.0 kPa-s, more preferably about 1.2 to about 6.5 kPa-s, even more preferably about 1.7 to about 6.0 kPa-s, and most preferably the viscosity is about 2.2 to about 5.5 kPa-s. The viscosity is a complex viscosity measurement that was performed on the Bohlin Rheometer which had a cone and plate system. The cone was a 4 cm 4° cone that was truncated with a 0.15 mm gap. A temperature sweep was performed from 20° to 45° C. at the rate of 5° C. per minute. The rheometer was equilibrated for 120 seconds prior to use and a 0.005 strain value was used. The oscillation value was 1 Hz and a light oil coating was placed around the edge.

The soft edible layer preferably has a fat content of about 2 to about 20 wt. %, more preferably the fat content is about 4 to about 15 wt. %, and most preferably about 6 to about 10 wt. % based on the weight of the soft edible layer. In addition, the protein content is preferably about 2 to about 20 wt. %, more preferably about 4 to about 15 wt. %, and most preferably about 8 to about 12 wt. % base on the weight of the soft edible layer. Furthermore, the sucrose in the soft edible layer is preferably about 30 to about 70 wt. %, more preferably about 40 to about 60 wt. % and most preferably about 45 to about 55 wt% based on the weight of the soft edible layer.

Optionally, a barrier may be applied around the edible core before applying the soft edible layer. For example, a film coating of hydroxy propyl methyl cellulose may be applied around the edible core to help protect the integrity of the edible core from heat during processing. Additionally, the edible core itself, may include hydroxy propyl methyl cellulose.

In a preferred embodiment, vitamins and/or process sensitive components, e.g., heat sensitive ingredients, are incorporated into the shelf stable edible product in either the edible core or in a separate layer that surrounds at least a portion of the edible core. By incorporating these components in this way, preservation of the components can be achieved, while minimizing impact to the flavor and texture of the product.

Optionally, the shelf stable edible snack may include preservatives, stabilizers, flavors, and the like.

The product design of the shelf stable edible snack and the selection of the processing method that will be employed will largely determine the application size of the base liquid and the dry component that is applied for forming the soft edible layer.

The weight ratio of the soft edible layer to the edible core will be dependent upon product design requirements. As a general guideline, the weight ratio is about 0.5:1 to about 6:1, preferably about 0.75:1 to about 5:1, and most preferably about 1:1 to about 4:1. In a preferred embodiment, the soft edible layer to edible core ratio is about 1:1.

The total moisture content, i.e. water content, of the shelf stable edible snack is from about 2% to about 30%, preferably from about 10% to about 23%, and more preferably from about 13% to about 17%.

In order to prevent microbiological spoilage of the shelf stable edible snack, it is important that the water activity of the edible core and the soft edible layer be controlled during manufacturing. For the purposes of this application, the water activity is defined as the vapor pressure of a composition divided by the vapor pressure of pure water under the same conditions. In the present invention, the water activity of the shelf stable edible product is designed to be sufficiently low enough, e.g., less than 0.85, to prevent the growth of most pathogenic and spoilage bacteria To inhibit the growth of molds and yeast, the water activity of the shelf stable edible product is ideally less than about 0.8.

The water activity of the edible core is less than about 0.8 at 25° C. Preferably, the water activity at 25° C. is from about 0.2 to about 0.8, more preferably from about 0.4 to about 0.75, even more preferably from about 0.5 to about 0.7, and most preferably from about 0.55 to about 0.65.

The soft edible layer has a water activity that is less than about 0.8 at 25° C. The preferred range for the water activity at 25° C. is from about 0.2 to about 0.8, more preferably from about 0.4 to about 0.75, even more preferably from about 0.5 to about 0.7, and most preferably from about 0.55 to about 0.65.

The amount of water that is in the soft edible layer prior to cooking (if cooking is involved) is from about 9 wt. % to about 16 wt. %. Preferably from about 10 wt. % to about 15 wt. %, more preferably from about 11 wt. % to about 14 wt. %, and most preferably from about 12 wt. % to about 13 wt. % of the soft edible layer is water.

The fat content of the shelf stable edible snack is from about 7% to about 30%, preferably from about 10% to about 20%, and most preferably from about 10% to about 18% based on the total weight of the shelf stable edible snack.

The soft edible layer has a fat content of from about 1% to about 10%, preferably, from about 3% to about 7%, and more preferably from about 5% to about 8%.

To extend the shelf life of the shelf stable edible snack, a packaging step may be included. The packaging step may involve nitrogen flushing to purge gases from the package. In addition, the package itself may be designed using high oxygen and/or high moisture barrier materials. For example, a multilayer structure providing high moisture and guaranteed oxygen barrier properties, such as polypropylene laminated to metalized polypropylene and/or a lamination with good hot tack and excellent sealing through particulate matter such as polypropylene laminated to polymeric ionomer may be used.

Non-limiting examples of the shelf stable edible snack include, a peanut core with a surrounding jelly layer, a jelly core with a cream cheese outer layer, a ham jerky core with an outer cheese layer, a jelly core surrounded by peanut butter, a cookie with an outer caramel layer, a confectionery core surrounded by a cookie dough layer and the like. In one embodiment, the edible snack is a pet food snack that has a meat center surrounded by a peanut butter or cheese layer.

The shelf stable edible snack of the present invention preferably has caloric density of about 1.5 to about 5 calories per gram. Preferably, the caloric density is about 2 to about 4 calories per gram.

It should be understood that the shelf stable edible snacks of the present invention are designed for human or animal consumption.

The following non-limiting examples provide formulation guidelines for making soft edible layer coatings of the present invention.

### EXAMPLE 1

Caramel Coating 1

| Ingredient | % |
|---|---|
| Dry Components | |
| Non-Fat Dry Milk | 0-100 |
| Sweetened Condensed Whole Milk | 0-100 |
| Sugar 6X | 0-50 |
| Wet Components | |
| High Fructose Corn Syrup | 85-100 |
| Water | 0-25 |
| Salt | 0-5 |
| Vanilla 4X Extract | 0-5 |
| Butter | 0-15 |
| Lecithin | 0-2 |

Pre Toast/Roast Procedure

Toast/Roast non-fat dry milk in an oven that has been preheated to a temperature of from about 120° C. (250° F.) to about 163° C. (325° F.) for 40 minutes, turning every 10 minutes to a golden brown color. Optionally, the milk powder may be milled and/or pulverized

Panning Procedure

1. Apply pastry flour to pan and add frozen edible cores.

2. Optionally, apply a film coating of hydroxy propyl methylcellulose (HPMC) and pastry flour to frozen edible cores or incorporate HPMC into the core.

3. Refreeze to −23.3° C. to −40° C. (−10° F. to −40° F.) for 10-20 minutes.

4. Apply alternating applications of wet and dry ingredients at a 1.8:3 ratio.

### EXAMPLE 2

Caramel Coating 2

| Ingredient | % |
|---|---|
| Dry Components | |
| Non-Fat Dry Milk | 0-100 |
| Sweetened Condensed Whole Milk | 0-100 |
| Sugar 6X | 0-50 |
| Wet Components | |
| Corn Syrup 63 DE | 70-90 |
| Water | 0-25 |
| Salt | 0-5 |
| Vanilla 4X Extract | 0-5 |
| Butter | 0-15 |
| Lecithin | 0-2 |

Pre Toast/Roast Procedure

Toast/Roast non-fat dry milk in an oven that has been preheated to a temperature of from about 121.1° C. (250° F.) to about 162.80C (325° F.) for 40 minutes, turning every 10 minutes to a golden brown color. Optionally, the milk powder may be milled and/or pulverized.

Panning Procedure

1. Apply pastry flour to pan and add frozen edible cores.

2. Optionally, apply a film coating of hydroxy propyl methylcellulose (HPMC) and pastry flour to frozen edible cores.

3. Refreeze to −23.3° C. to −40° C. (−10° F. to −40° F.) for 10-20 minutes.

4. Apply alternating applications of wet and dry ingredients at a 1.8:3 ratio.

### EXAMPLE 3

Cookie Dough Coating

| Ingredient | % |
|---|---|
| Dry Components | |
| Powdered Brown Sugar | 0-30 |
| Powdered Confectioners Sugar | 0-30 |
| (6X or 10X) | |
| Low Micro Flour | 20-70 |
| Chopped Dark Chocolate | 0-30 |
| Wet Components | |
| Corn Syrup 63 DE | 20-80 |
| Salt | 0-6 |
| Vanilla | 0-6 |
| Anhydrous Milk Fat | 0-40 |
| Water | 0-40 |

Panning Procedure

1. Apply pastry flour to pan and add frozen edible cores.

2. Optionally, apply a film coating of hydroxy propyl methylcellulose (HPMC) and pastry flour to frozen edible cores.

3. Refreeze to −23.3° C. to −40° C. (−10° F. to −40° F.) for 10-20 minutes.

4. Apply alternating applications of wet and dry ingredients at a 1.8:3 ratio.

While the invention has been described above with reference to specific embodiments thereof, it is apparent that many changes, modifications, and variations can be made without departing from the inventive concept disclosed herein. Accordingly, it is intended to embrace all such changes, modifications, and variations that fall within the spirit and broad scope of the appended claims. All patent applications, patents, and other publications cited herein are incorporated by reference in their entirety.

What is claimed is:

1. A method of making a shelf stable edible snack, comprising the steps of:
(A) providing an edible core having an outside surface; and
(B) applying at least one soft edible layer that substantially covers said outside surface of said edible core; wherein said soft edible layer is applied by a method comprising the steps of:
(a) coating said outside surface of said edible core with a base liquid, thereby forming a liquid coated core;
(b) applying a dry component to said liquid coated core, thereby forming an edible layered component; and
(c) optionally, (i) drying said liquid coated core after step (a), (ii) drying said edible layered component after step (b), or (iii) drying said edible layered component after steps (a) and (b);
wherein said soft edible layer has a water activity of about 0.2 to about 0.8 at 25° C. and a hardness value of 6 or less as determined by Descriptive Analysis Testing in ASTM MNL13.

2. The method of claim 1, wherein said soft edible layer contains a non-sucrose component.

3. The method of claim 1, wherein said soft edible layer has a water activity of about 0.4 to about 0.75 at 25° C.

4. The method of claim 1, further comprising step (d) coating said edible layered component with a second liquid and step (e) applying a second dry component to said liquid coated component of step (d).

5. The method of claim 4, further comprising step (f) drying said liquid coated core after step (d) and/or drying said edible layered component after step (e).

6. The method of claim 1, wherein said base liquid comprises a liquid component selected from the group consisting of: corn syrups, glycerin, salt, fats, flavorings, acids, lecithin, fruit juices, fruit juice derivatives, and mixtures thereof.

7. The method of claim 1, wherein said dry component is fat based, dough based, dairy based, protein based, grain based, or mixtures thereof.

8. The method of claim 1, wherein said dry component comprises a dry ingredient selected from the group consisting of: powdered sugars, wheat flours, peanut flours, cheese powders, milk powders, yogurt powders, salt, dextrose, cream cheese powders, maltodextrin, flavorings, herbs, spices, emulsifiers, enzymes, and mixtures thereof.

9. The method of claim 1, wherein at least a portion of said dry component is treated to a roasting step.

10. The method of claim 1, wherein said edible core is selected from the group consisting of nuts, nut derivatives, meats, meat derivatives, fruits, fruit derivatives, cookie bits, crackers, cheese, cheese derivatives, legumes, yogurts, yogurt derivatives, tomato sauces, vegetables, vegetable derivatives, confectioneries, and mixtures thereof.

11. The method of claim 1, wherein said edible core is comprised of peanut butter and said soft edible layer is jelly.

12. The method of claim 1, wherein said soft edible layer is selected from the group consisting of a peanut butter, jelly, cheese, caramel, cream cheese, and mixtures thereof.

13. The method of claim 1, wherein said shelf stable edible snack is bite sized.

14. A shelf stable edible snack comprising:
an edible core having an outer surface selected from the group consisting of: nuts, nut-derivatives, meats, meat derivatives, fruits, fruit derivatives, cookie bits, crackers, cheese, cheese derivatives, legumes, yogurts, yogurt derivatives, tomato sauces, vegetables, vegetable derivatives, confectioneries, and mixtures thereof; and
a tacky soft edible layer,
wherein said tacky soft edible layer substantially surrounds said edible core and said outer surface of said soft edible layer has a water activity that is about 0.2 to about 0.8 at a temperature of 25° C. and
wherein said soft edible layer has a density of at least about 0.99 g/cc and wherein said shelf stable edible snack is microbiologically stable for at least 2 months, and wherein said soft edible layer has a hardness value of 6 or less as determined by Descriptive Analysis Testing in ASTM ML13.

15. The shelf stable edible snack of claim 14, wherein said shelf stable edible snack is bite sized.

16. The shelf stable edible snack of claim 14, wherein said soft edible layer is comprised of corn syrups, glycerin, salt, fats, flavorings, acids, lecithin, fruit juices, fruit juice derivatives, powdered sugars, wheat flours, peanut flours, cheese powders, milk powders, yogurt powders, salt, dextrose, cream cheese powders, maltodextrin, flavorings, herbs, spices, emulsifiers, enzymes, and mixtures thereof.

17. The shelf stable edible snack of claim 14, wherein said edible core is comprised of peanut butter and said soft edible layer is jelly.

18. The shelf stable edible snack of claim 14, wherein said soft edible layer is caramel.
